(19) United States
(12) Patent Application Publication
(10) Pub. No.: US 2020/0362468 A1
(43) Pub. Date: Nov. 19, 2020

(54) ELECTROLYTIC MANGANESE DIOXIDE AND A METHOD OF PREPARING THEREOF

(71) Applicant: Octopus Technologies Inc., Vancouver (CA)

(72) Inventors: Arman BONAKDARPOUR, Vancouver (CA); David P. WILKINSON, North Vancouver (CA); Farhang NESVADERANI, North Vancouver (CA); Ivan STOSEVSKI, Vancouver (CA)

(21) Appl. No.: 16/762,134

(22) PCT Filed: Nov. 7, 2018
(86) PCT No.: PCT/CA2018/051407

§ 371 Date: May 6, 2020

Related U.S. Application Data
(60) Provisional application No. 62/583,952, filed on Nov. 9, 2017.

(51) Int. Cl. C25B 1/21; H01M 4/50; H01M 10/26; C25B 9/10

(52) U.S. Cl. CPC C25B 1/21; H01M 4/50; H01M 2300/002; C25B 9/10; H01M 10/26

(57) ABSTRACT

The present disclosure relates to an electrolytic manganese dioxide composition comprising two manganese dioxide phases, at least one of the two manganese dioxide phases having at least a portion that exhibits amorphicity. The two manganese dioxide phases may be present in a ratio of between 9:1 and 1:3. The two manganese dioxide crystal phases may be akhtenskite and ramsdellite. The present disclosure further relates to a battery comprising said electrolytic manganese dioxide composition, and methods of manufacturing said electrolytic manganese dioxide composition. The present disclosure further relates to manufacturing an electrode within a cell, the cell for use as a battery, the electrode comprising electrolytic manganese dioxide composition consisting essentially of two manganese dioxide crystal phases.

### TECHNICAL FIELD

The present disclosure relates to an electrolytic manganese dioxide composition. The present disclosure also relates to a method of preparing an electrolytic manganese dioxide composition. The present disclosure also relates to a rechargeable battery incorporating an electrolytic manganese dioxide composition therein.

### BACKGROUND

Manganese dioxide (MnO₂) is an inorganic compound that is commonly used as a material in batteries and pigments, and as a precursor material to other compositions comprising manganese. Like many inorganic compounds, manganese dioxide is naturally occurring and exists as different polymorphs or phases. Such polymorphs include, but may not be limited to, α-MnO₂, β-MnO₂ (pyrolusite), γ-MnO₂ (ramsdellite), and ε-MnO₂ (akhtenskite). Despite its natural occurrence, however, manganese dioxide that is intended for commercial applications is commonly synthesized.

Manganese dioxide that is intended for current commercial applications is typically formed by either chemical means or electrolytic means. Known electrolytic manganese dioxide compositions (“EMD”s) are commonly manufactured from an H₂SO₄—MnSO₄ electrolytic process. Such process typically involves synthesizing EMD in a hot sulfuric acid bath (e.g. between about 90° C. and about 100° C.).

EMD that is currently commercially available typically comprises the three phases of akhtenskite, ramsdellite, and pyrolusite in varying ratios. Referring to FIG. 1(a), an example of an XRD diffractogram of an EMD that is currently commercially available (i.e. TOSOH-HH) comprising about 40 wt % akhtenskite, about 59 wt % ramsdellite, and about 1 wt % pyrrolusite, is provided. Referring to FIG. 1(b), an example of an XRD diffractogram of another EMD that is currently commercially available (i.e. Erachem) comprising about 52 wt % akhtenskite, about 47 wt % ramsdellite, and about 1 wt % pyrrolusite is provided. Polymorphs present in EMDs that are currently commercially available generally display high crystallinity.

Owing to the relative abundance, low toxicity, and low cost of manganese dioxide, manganese dioxide is commonly used in the production of alkaline Zn/MnO₂ batteries, and Zn/MnO₂ batteries themselves occupy a significant portion of the battery market share. In general, Zn/MnO₂ batteries comprise a cathode (i.e. one that comprises an EMD that is currently commercially available as the active cathodic material), an anode (i.e. one that comprises zinc metal as the active anodic material), and an alkaline electrolytic solution (e.g. a potassium hydroxide solution) with which both the cathode and anode are in fluid contact. During operation of an alkaline Zn/MnO₂ battery, zinc anodic material is oxidized, the EMD cathodic material is reduced, and an electric current directed towards an external load is generated. Upon recharging such battery, by-products formed as a result of the reduction of manganese dioxide are oxidized to re-form electrolytic manganese dioxide. Similarly, by-products formed as a result of the oxidation of zinc metal are reduced to re-form zinc metal.

In addition to alkaline Zn/MnO₂ batteries, manganese dioxide may also be incorporated into lithium-based and sodium-based batteries (Biswal et al., Electrolytic manganese dioxide (EMD): a perspective on worldwide production, reserves and its role in electrochemistry, RSC Adv., 2015, 5, 58255-58283).

Batteries or capacitors incorporating EMD as the cathodic material generally possess desirable characteristics such as, but not limited to, high voltage output, high energy density, good shelf life, low drain rate, low polarization, and high discharge capacities. However, the cyclability of such batteries or capacitors traditionally has been poor. In addition, while the EMD produced from current commercial manufacturing processes may be suitable for many electronic applications, there is suggestion that such EMD may not satisfy the energy output requirements of new generations of electronic devices.

Furthermore, it has been noted that the alkaline electrolytic environment of an alkaline Zn/MnO₂ battery contributes to the formation of irreversible by-products such as, but not limited to, ZnO or Zn(OH)₂ formed on the anode and Mn(OH)₂, Mn₃O₄, and Mn₂O₃ formed on the cathode (Shen et al., Power Sources, 2000, 87, 162). The formation of such irreversible by-products as a result of battery operation may lead to undesirable consequences such as capacity fading, poor Coulombic efficiencies, or both.

### SUMMARY

The present disclosure relates to an electrolytic manganese dioxide composition. The present disclosure also relates to a method of preparing an electrolytic manganese dioxide composition. The present disclosure also relates to a rechargeable battery incorporating an electrolytic manganese dioxide composition therein.

According to an aspect of the disclosure, there is described an electrolytic manganese dioxide composition comprising two manganese dioxide phases, at least one of the two manganese dioxide phases having at least a portion that exhibits amorphicity. The two manganese dioxide phases may be akhtenskite and ramsdellite. The ratio of the two manganese dioxide phases may be between 9:1 and 1:3.

According to another aspect of the disclosure, there is described a battery comprising a cathode, an anode, a separator disposed between the cathode and the anode, and an electrolytic solution in fluid contact with the cathode, anode, and separator. The cathode comprises an electrolytic manganese dioxide composition comprising two manganese dioxide phases, at least one of the two manganese dioxide phases having at least a portion that exhibits amorphicity. The two manganese dioxide phases may be akhtenskite and ramsdellite. The ratio of the two manganese dioxide phases may be between 9:1 and 1:3. The operating pH of the battery may be between 3 and 7.

According to another aspect of the disclosure, there is described a method of preparing an electrolytic manganese dioxide composition comprising two manganese dioxide phases, at least one of the two manganese dioxide phases having at least a portion that exhibits amorphicity. The method comprises applying a potential of between about 1.8 V_{cell} and about 2.5 V_{cell} between a cathode and an anode over a pre-determined period of time, the cathode and anode in contact with an electrolytic solution comprising a species comprising manganese, forming the electrolytic manganese dioxide composition and depositing the electrolytic manganese dioxide composition onto the anode, and maintaining the pH of the electrolytic solution between 3 and 7. A pressure of between about 10 PSI and 100 PSI may be applied during the synthesis process.

According to another aspect of the disclosure, there is described a method of preparing an electrolytic manganese dioxide electrode directly in a cell for use as a battery, the electrolytic manganese dioxide electrode comprising an electrolytic manganese dioxide composition, the electrolytic manganese dioxide composition comprising two manganese dioxide crystal phases, at least one of the two manganese dioxide phases having at least a portion that exhibits amorphicity. The method comprises: (a) providing a cell comprising a cathode, an anode, a separator in between the cathode and the anode, wherein the cathode, the anode, and the separator are in fluid contact with an electrolytic solution, and the electrolytic solution comprises a species comprising manganese; (b) charging and discharging the cell; (c) holding the cell at a potential for two or more hours prior to discharging the cell; (d) forming the electrolytic manganese dioxide composition and depositing the electrolytic manganese dioxide composition onto the anode.

A battery comprising two manganese dioxide phases, at least one of the two manganese dioxide phases having at least a portion that exhibits amorphicity, may exhibit improved cyclability over batteries comprising EMDs that are currently commercially available.

A battery comprising two manganese dioxide phases, at least one of the two manganese dioxide phases having at least a portion that exhibits amorphicity, may exhibit improved specific capacity over batteries comprising EMDs that are currently commercially available. A battery comprising two manganese dioxide phases, at least one of the two manganese dioxide phases having at least a portion that exhibits amorphicity, may exhibit less capacity fade with usage than batteries comprising EMDs that are currently commercially available.

This summary does not necessarily describe the entire scope of all aspects of the disclosure. Other aspects, features and advantages will be apparent to those of ordinary skill in the art upon review of the following description of specific embodiments.

### BRIEF DESCRIPTION OF THE DRAWINGS

In the accompanying drawings, which illustrate one or more exemplary embodiments:

FIG. 1(a) is an x-ray diffraction (XRD) diffractogram of an electrolytic manganese dioxide composition that is currently commercially available (i.e. TOSOH-HH), the XRD diffractogram revealing the presence of akhtenskite, ramsdellite, and pyrrolusite in the electrolytic manganese dioxide composition.

FIG. 1(b) is an XRD diffractogram of an electrolytic manganese dioxide composition that is currently commercially available (i.e. Erachem), the XRD diffractogram revealing the presence of akhtenskite, ramsdellite, and pyrrolusite in the electrolytic manganese dioxide composition.

FIG. 2(a) is an XRD diffractogram of a neutral EMD (as defined herein), and according to a first embodiment, the XRD diffractogram revealing the presence of akhtenskite and ramsdellite in the electrolytic manganese dioxide composition.

FIG. 2(b) is an XRD diffractogram of a neutral EMD, and according to a second embodiment (i.e. NiZnAc), the XRD diffractogram revealing the presence of akhtenskite and ramsdellite in the electrolytic manganese dioxide composition.

FIG. 2(c) is an XRD diffractogram of a neutral EMD, and according to a third embodiment (i.e. FNB088), the XRD diffractogram revealing the presence of akhtenskite and ramsdellite in the electrolytic manganese dioxide composition.

FIG. 2(d) is an XRD diffractogram of a neutral EMD, and according to a fourth embodiment (i.e. ISA19_05), the XRD diffractogram revealing the presence of akhtenskite and ramsdellite in the electrolytic manganese dioxide composition.

FIG. 2(e) is an XRD diffractogram of a neutral EMD, and according to a fifth embodiment (i.e. ISA19_02), the XRD diffractogram revealing the presence of akhtenskite and ramsdellite in the electrolytic manganese dioxide composition.

FIG. 2(f) is an XRD diffractogram of a neutral EMD, and according to a sixth embodiment (i.e. ISA19_01), the XRD diffractogram revealing the presence of akhtenskite and ramsdellite in the electrolytic manganese dioxide composition.

FIG. 3 is an exploded view of a cell for use in the manufacturing of an electrode comprising a neutral EMD.

FIG. 4(a) is an exploded view of a cell for use in the manufacturing of an electrode comprising a neutral EMD, the electrode manufactured “in-situ” of the cell.

FIG. 4(b) is a capacity versus cycling plot of the cell in FIG. 4(a) during the in situ preparation of the electrode therein.

FIG. 5 is a Pourbaix diagram depicting general operating conditions of a battery comprising a neutral EMD.

FIG. 6(a) is a specific capacity versus cycle number plot of batteries comprising an Ex-situ NEMD electrode (as defined herein) or an NEMD powder electrode (as defined herein), and a battery comprising an electrode formed from EMD that is commercially available.

FIG. 6(b) is a voltage versus specific capacity plot of the batteries of FIG. 6(a), as collected during the fifth discharge of the batteries' cyclability testing.

FIG. 7 depicts dQ/dV plots of a battery comprising an electrode formed from EMD that is commercially available and a battery comprising an NEMD powder electrode that have undergone a plurality of charge and discharge cycles.

FIG. 8(a) is a specific capacity versus cycle number plot of batteries comprising an Ex-situ NEMD electrode or an NEMD powder electrode, and a battery comprising an electrode formed from EMD that is commercially available.

FIG. 8(b) is a specific energy versus cycle number plot of the batteries of FIG. 8(a).

FIG. 8(c) is a voltage versus specific capacity plot of the batteries of FIG. 8(a), as collected during the fifth discharge of the batteries' cyclability testing.

FIG. 9 is a comparison of the XRD diffractograms of an EMD that is currently commercially available and of a neutral EMD.

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

In this disclosure, the terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

In this disclosure, the term “about”, when followed by a recited value, means plus or minus 10% of that recited value.

In this disclosure, the term “battery” contemplates an electrochemical cell or two or more electrochemical cells connected together in series, in parallel, or a combination thereof. As used herein, the term “cell” contemplates an electrochemical cell or two or more electrochemical cells connected together in series, in parallel, or a combination thereof. As used herein, the terms “battery” and “cell” are interchangeable.

In this disclosure, a “C rate” refers to a rate at which a battery is discharged relative to an MnO₂ operationally achievable specific capacity of 200 mAh g⁻¹. For example, a 2C rate would discharge an entire MnO₂ electrode of specific capacity of 200 mAh g⁻¹ in 30 minutes, a 1C rate would discharge an entire MnO₂ electrode of specific capacity of 200 mAh g⁻¹ in 1 hour, a C/2 rate would discharge an entire MnO₂ electrode of specific capacity of 200 mAh g⁻¹ in 2 hours, and a C/10 rate would discharge an entire MnO₂ electrode of specific capacity of 200 mAh g⁻¹ in 10 hours.

In this disclosure, the term “cut-off capacity” or “capacity cut-off” refers to a coulometric capacity at which a discharge step of a battery is stopped.

In this disclosure, the term “cut-off voltage” or “voltage cut-off” refers to a voltage of a battery at which: (i) a discharge step is stopped; or (ii) a charge step is stopped.

The present disclosure relates, at least in part, to an EMD comprising various phases of manganese dioxide, at least one of the manganese dioxide phases having at least a portion that exhibits amorphicity. In some embodiments, the EMD comprises akhtenskite and ramsdellite. In some embodiments, the EMD consists essentially of akhtenskite and ramsdellite. In some embodiments, the EMD consists of akhtenskite and ramsdellite. In some embodiments, no phase other than akhtenskite and ramsdellite is detected in the EMD. The degree of crystallinity, amorphicity, or both of the EMD can vary. The degree of surface area of the EMD can also vary. The lattice spacing of akhtenskite, ramsdellite, or both in the EMD can vary. The unit cell of akhtenskite, ramsdellite, or both in the EMD can vary.

### Electrolytic Manganese Dioxide Composition

As contemplated herein, there is an electrolytic manganese dioxide composition comprising akhtenskite and ramsdellite, at least one of the manganese dioxide phases having at least a portion that exhibits amorphicity. For example, at least a portion of the ramsdellite may exhibit amorphicity. The electrolytic manganese dioxide composition can comprise about 30 wt % to about 90 wt % akhtenskite. For example, the electrolytic manganese dioxide composition can comprise 30 wt %, 40 wt %, 50 wt %, 60 wt %, 70 wt %, 80 wt %, 90 wt % of akhtenskite. The electrolytic manganese dioxide composition can comprise about 10 wt % to about 70 wt % ramsdellite. For example, the electrolytic manganese dioxide composition can comprise 10 wt %, 20 wt %, 30 wt %, 40 wt %, 50 wt %, 60 wt %, 70 wt % of ramsdellite. The ratio of akhtenskite to ramsdellite can be between about 9:1 to about 3:9. Such electrolytic manganese dioxide compositions may each be referred to as “neutral EMD”.

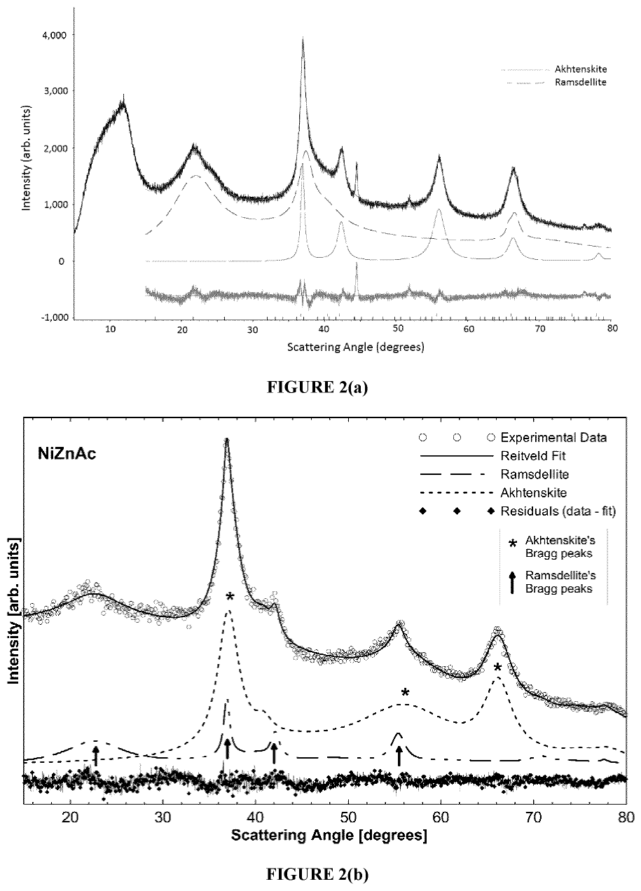

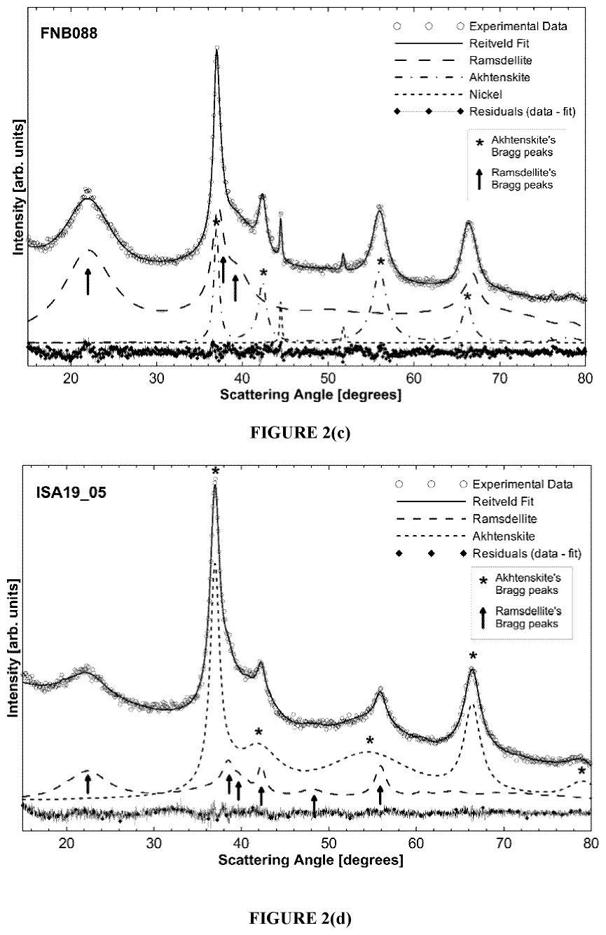

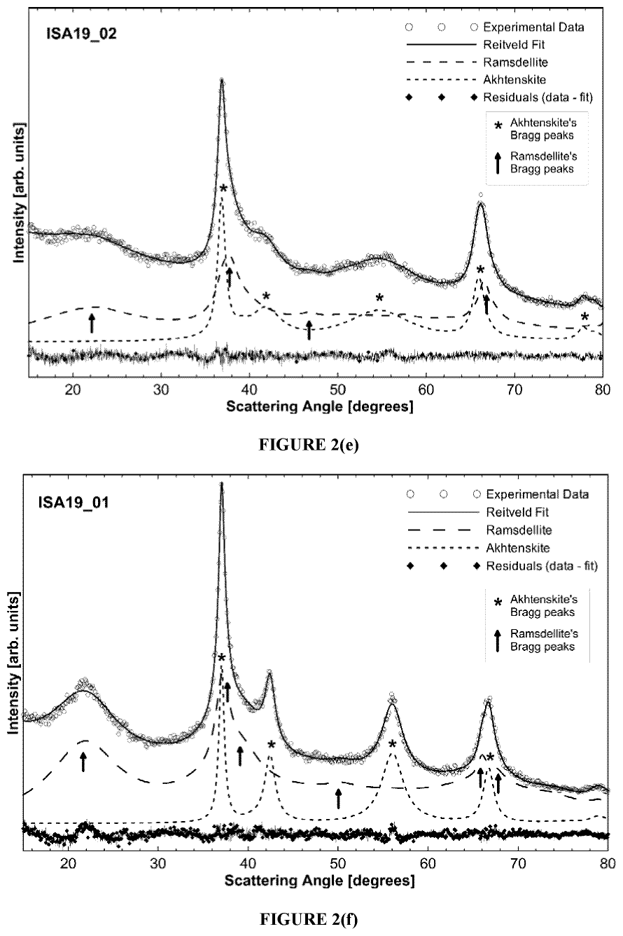

Referring to the XRD diffractogram of FIG. 2(a), and according to a first embodiment, there is an electrolytic manganese dioxide composition comprising akhtenskite and ramsdellite, at least one of the manganese dioxide phases having at least a portion that exhibits amorphicity. No phase other than akhtenskite and ramsdellite (e.g. pyrolusite) is detected. As contemplated in this embodiment, the electrolytic manganese dioxide composition consists essentially of 24.82 wt % akhtenskite and 75.18 wt % ramsdellite, and has an akhtenskite to ramsdellite ratio of about 1:3.

Table 1 below provides a non-limiting list of other embodiments of neutral EMD (i.e. those identified as “non-commercial”), as compared against EMDs that are currently commercially available (i.e. those identified as “commercial”). The XRD diffractograms of these other non-limiting embodiments of neutral EMD are provided at FIGS. 2(b) to 2(f):

### Table 1

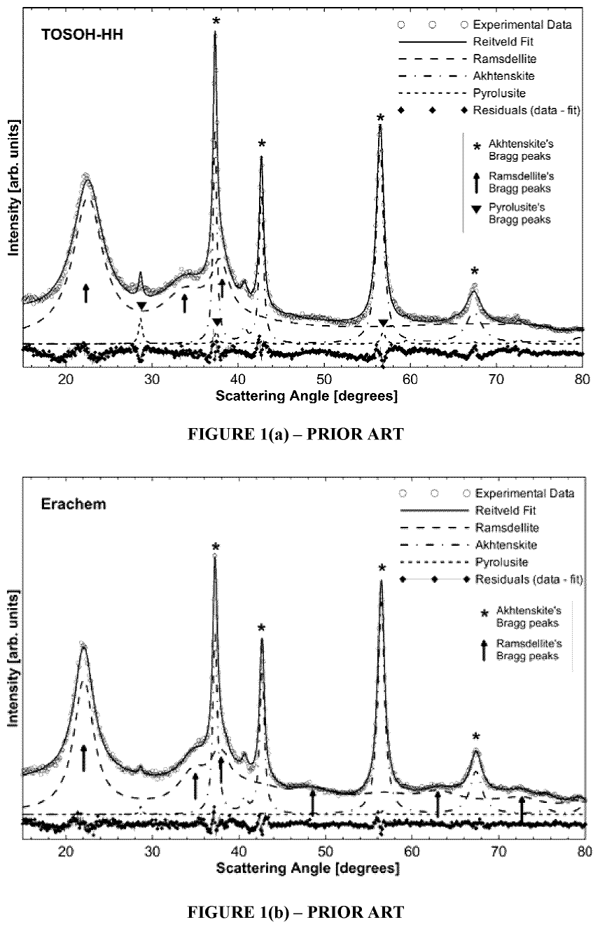

TABLE 1

| | Ramsdellite Content | Akhtenskite Content | Pyrolusite Content | |
|---|---|---|---|---|
| ID | (wt %) | (wt %) | (wt %) | Type |
| Commercial EMD | 47 | 52 | 1 | Powder |
| (Erachem) | | | | |
| (see FIG. 1(b)) | | | | |
| Commercial EMD | 59 | 40 | 1 | Powder |
| (TOSOH-HH) | | | | |
| (see FIG. 1(a)) | | | | |
| Non-commercial | 11 | 89 | — | Powder |
| NiZnAc | | | | |
| (see FIG. 2(b)) | | | | |
| Non-commercial | 62 | 38 | — | Powder |
| ISA019_01 | | | | |
| (see FIG. 2(f)) | | | | |
| Non-commercial | 14 | 86 | — | Powder |
| ISA019_05 | | | | |
| (see FIG. 2(d)) | | | | |
| Non-commercial | 43 | 57 | — | Powder |
| ISA019_02 | | | | |
| (see FIG. 2(e) | | | | |
| Non-commercial | 37 | 63 | — | Powder |
| ISA019_03 | | | | |
| Non-commercial | 66 | 34 | — | Powder |
| FNB088 | | | | |
| (see FIG. 2(c)) | | | | |

Neutral EMD may have crystal structures that are more disordered than EMDs that are currently available, the degree of disorder being measured by the grain size of the crystal phases. For example, neutral EMD may display a smaller Ramsdellite grain size than EMDs that are currently available. In some embodiments, EMDs produced herein display a Ramsdellite grain size that is about half that of the Ramsdellite grain size in EMDs that are currently available. In some embodiments, neutral EMDs display a Ramsdellite grain size that is about one-third that of the Ramsdellite grain size in EMDs that are currently available. In another example, neutral EMDs may display a smaller Akhtenskite grain size than EMDs that are currently available. In some embodiments, neutral EMDs display a Akhtenskite grain size that is about five-sixths that of the Akhtenskite grain size in EMDs that are currently available. An example comparison is also provided in Example 4, below.

### Preparation of Electrolytic Manganese Dioxide Compositions

Neutral EMD is synthesized by electrolysis. Neutral EMD may be formed and processed into a powder or other suitable form. Such processed neutral EMD may be referred to as “NEMD powder” in this disclosure.

According to a first embodiment of a process of synthesizing a neutral EMD, there is provided an electrochemical cell for such synthesis. The electrochemical cell comprises a cathode, an anode, and an electrolytic solution therebetween. In other embodiments, any other suitable cell can be used.

The anode comprises a nickel metal foil (e.g. MF-NiFoil-25u produced by MTI Corporation) of a suitable width, height, and thickness. For example, the anode can be 4 cm wide, 14 cm high, and 0.04 mm thick. In other embodiments, the anode comprises another suitable current collecting material, possesses other specific physical characteristics, or both. Examples of other suitable current collecting materials of other specific physical characteristics include, but are not limited to, metal foams, 3D metals, carbon papers, porous carbon, graphite, and 3-D structured carbon. With reference to porous anodes (including foam materials), and without being bound by theory, it is believed that the high surface area of porous anodes enables deposition of thinner layers of manganese dioxide for the same loading, thus enabling better utilization of the deposited manganese dioxide.

The cathode comprises a zinc metal foil (e.g. zinc produced by Dexmet Corporation) of a suitable width, height, and thickness. For example, the cathode can be 4 cm wide, 14 cm high, and 0.5 mm thick. In other embodiments, the cathode can be any suitable material including, but not limited to, nickel metal foil, platinum metal foil, tin-based, indium-based, and carbon-based materials.

The electrolytic solution comprises a zinc-based salt dissolved therein. As contemplated in this embodiment, the electrolytic solution comprises about 2.0M zinc sulfate heptahydrate. In other embodiments, the electrolytic solution comprises other concentrations of zinc sulfate heptahydrate. Examples of suitable concentrations of zinc sulfate heptahydrate include, but are not limited to, those ranging from about 0.5M to saturation, about 0.5M to about 2.5M, about 1.0M to saturation, about 1.0M to about 2.5M, about 1.5M to saturation, and about 1.5M to about 2.5M. For example, zinc sulfate heptahydrate can be present in solution at a concentration of about 0.5M, 0.6M, 0.7M, 0.8M, 0.9M, 1.0M, 1.1M, 1.2M, 1.3M, 1.4M, 1.5M, 1.6M, 1.7M, 1.8M, 1.9M, 2.0M, 2.1M, 2.2M, 2.3M, 2.4M, 2.5M. In other embodiments, other hydrated zinc sulfates or non-hydrated zinc sulfate dissolved in the electrolytic solution at the same or a similar concentration as above can be used. In other embodiments, the zinc-based salt can be, but is not limited to, zinc nitrate, zinc chloride, zinc triphlate, or a combination thereof that is dissolved in the electrolytic solution at a suitable concentration.

The electrolytic solution further comprises about 1.0M manganese sulfate monohydrate. In other embodiments, the electrolytic solution comprises other suitable concentrations of manganese sulfate monohydrate. Examples of suitable concentrations of manganese sulfate monohydrate include, but are not limited to, those ranging from about 0.1M to about 1.5M, about 0.6M and about 1.5M, about 0.6M and about 1.0M, about 0.1M and about 0.6M. For example, the electrolytic solution can comprise a concentration of manganese sulfate monohydrate of, but not limited to, about 0.1M, 0.2M, 0.3M, 0.4M, 0.5M, 0.6M, 0.7M, 0.8M, 0.9M, 1.0M, 1.1M, 1.2M, 1.3M, 1.4M, 1.5M. In other embodiments, other hydrated manganese sulfates or non-hydrated manganese sulfate dissolved in the electrolytic solution at the same or a similar concentration as above can be used. In other embodiments, the electrolytic solution comprises another suitable manganese species that has the same or substantially similar function as manganese sulfate monohydrate.

To synthesize a neutral EMD, a potential of about 1.8 V_{cell} to about 2.5 V_{cell} (e.g. between 1.8 V_{cell} and 2.5 V_{cell}) is applied between the cathode and anode over a pre-determined period of time (e.g. 18 hours, 24 hours, 48 hours). For example, a potential of 1.8 V_{cell}, 1.9 V_{cell}, 2.0 V_{cell}, 2.1 V_{cell}, 2.2 V_{cell}, 2.3 V_{cell}, 2.4 V_{cell}, 2.5 V_{cell}, can be applied between the cathode and the anode. In other embodiments, a current of about 0.2 mA cm⁻² to about 10.0 mA cm⁻² (e.g. about 3.0 mA cm⁻² to about 4.0 mA cm⁻²; about 3.5 mA cm⁻² to about 5.0 mA cm⁻²) is applied between the cathode and the anode. Manganese dioxide synthesis conditions are maintained at room temperature (i.e. about 20° C. to about 25° C.) over the pre-determined period of time. Neutral EMD is synthesized in the cell and deposits on the surface of the anode over the pre-determined period of time. As contemplated in this first embodiment, a potential of 2.5 V_{cell} is applied between the cathode and anode over 24 hours.

As contemplated in this first embodiment, neutral EMD is synthesized in an environment where the pH is between about 3.5 and about 4.3. For example, the pH environment can be 3.5, 3.6, 3.7, 3.8, 3.9, 4.0, 4.1, 4.2, 4.3.

Synthesized neutral EMD deposited on the surface of the anode is removed from the surface of the anode, recovered from the electrolytic solution, and dried. For example, the anode (with the neutral EMD deposited thereon) is removed from the electrochemical cell. The neutral EMD is sprayed with de-ionized water to remove it from the surface of the anode. The removed neutral EMD is washed by stirring the removed neutral EMD in de-ionized water for a pre-determined period of time. For example, the pre-determined period of time can be any period of time including, but not limited to, between about 3 hours and about 8 hours. For example, the pre-determined period of time can be any period of time including, but not limited to, about 3 hours, 4 hours, 5 hours, 6 hours, 7 hours, 8 hours. As contemplated in this non-limiting embodiment, the pre-determined period of time is about 8.0 hours. The de-ionized water is then decanted, and the neutral EMD is washed again in de-ionized water for a pre-determined period of time; the de-ionized water is decanted. The washing steps may be repeated as frequently as desired.

As contemplated in the first embodiment, the neutral EMD is then centrifuged at 3000 rpm to separate it from any remaining de-ionized water, and the recovered neutral EMD is dried. Examples of suitable drying conditions include, but are not limited to drying the recovered electrolytic manganese dioxide at elevated temperatures (e.g. about 50° C. to about 90° C., about 50° C. to about 80° C., about 50° C. to about 70° C., about 50° C. to about 60° C., about 60° C. to about 90° C., about 60° C. to about 80° C., about 60° C. to about 70° C., about 70° C. to about 90° C., about 70° C. to about 80° C., about 80° C. to about 90° C.) for a pre-defined time (e.g. 3 hours, 4 hours, 5 hours, 6 hours, 7 hours, 8 hours). As contemplated in this first embodiment, the recovered neutral EMD is rendered into powder form. In other embodiments, the recovered neutral EMD can be in any other suitable form. In other embodiments, neutral EMD may be recovered by any other suitable method known in the art.

In other embodiments, the electrolytic solution further comprises a suitable pH buffer system that is present at a suitable concentration in the electrolytic solution. Suitable concentrations include, but are not limited to, concentration ranges between about 0.05M and about 0.20M, about 0.05M and about 0.25M, about 0.05M and about 0.20M, about 0.05M and about 0.15M, about 0.06M and about 0.19M, about 0.07M and about 0.18M, about 0.08M and about 0.16M, and about 0.09M and about 0.15M. For example, suitable concentrations include, but are not limited to, about 0.01M, 0.02M, 0.03M, 0.04M, 0.05M, 0.06M, 0.07M, 0.08M, 0.09M, 0.10M, 0.11M, 0.12M, 0.13M, 0.14M, 0.15M, 0.16M, 0.17M, 0.18M, 0.19M, and 0.20M. Examples of suitable pH buffer systems include, but are not limited to, those selected from acetates, sulfates, and combinations thereof. An example of a suitable buffer system is one that comprises Mn(CH₃COO)₂ and Na₂SO₄ dissolved in the electrolytic solution each at a concentration of about 0.1M. Another example of a suitable buffer system is one that consists essentially of Mn(CH₃COO)₂ and Na₂SO₄ each dissolved in the electrolytic solution at a concentration of about 0.1M. With the presence of a suitable pH buffer system, the environment in which the neutral EMD is synthesized generally has a pH between about 4.5 to about 5.5. For example, the pH environment can be between about 5.5 and about 6.5. For example, the pH environment can be 4.5, 4.6, 4.7, 4.8, 4.9, 5.0, 5.1, 5.2, 5.3, 5.4.

In other embodiments, the synthesis occurs at any other suitable temperature other than room temperature including, but not limited to, temperature ranges between about 5° C. and 10° C., about 5° C. and 15° C., about 5° C. and 19° C., about 26° C. to 35° C., about 36° C. to 45° C., about 46° C. to 55° C., about 56° C. to 65° C., about 66° C. to 75° C., about 76° C. to 85° C., about 86° C. to 95° C. For example, the synthesis of EMD can occur at 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C.

In other embodiments, any suitable pH buffer system that maintains the pH of the electrolytic solution between about 3 and about 7 can be used. Suitable pH buffer systems include, but are not limited to, citrates, phosphates, and combinations thereof. In other embodiments, any suitable pH buffer system that maintains the pH of the electrolytic solution between about 0 and about 7 can be used. In other embodiments, any suitable pH buffer system that maintains the pH of the electrolytic solution between about 7 and about 9 can be used.

It is believed that less energy demands and less heat aggressive conditions are required in synthesizing neutral EMD than synthesizing EMD using commercial processes, such processes frequently including maintaining synthesis conditions at a high temperature (e.g. 90° C. to 100° C.) for sometimes prolonged periods of time (e.g. 12 to 24 hours).

NEMD powder may be adapted for use in a battery (e.g. Zn/MnO₂ battery). NEMD powder may be used in a battery (e.g. Zn/MnO₂ battery).

Manufacturing an Electrode from NEMD Powder

NEMD powder may be combined with a current collector to form an electrode. An electrode comprising or formed from NEMD powder may be referred to as an “NEMD powder electrode” in this disclosure.

In a first embodiment of an NEMD powder electrode, the NEMD powder is mixed with carbon black (e.g. Vulcan® XC72R) and then added to a 7 wt % polyvinylidene fluoride (e.g. EQ-Lib-PVDF, MTI Corporation) and n-methyl-2-pyrrolidone (e.g. EQ-Lib-NMP, MTI Corporation) based solution, to form a mixture. The mixture is spread onto a carbon paper current collector substrate (e.g. TGP-H-120 carbon paper). The mixture is dried on the substrate at about 100° C. for 18 hours. Upon drying, an NEMD powder electrode is formed. The ratio of NEMD powder to carbon black to PVDF in the formed NEMD powder electrode is 7:2:1.

The current collector substrate can be a substantially 2-D structure or a 3-D structure. The current collector substrate can have different degrees of porosity (e.g. 5% to 70%) and tortuosity. In some embodiments, the current collector substrate can be a metal, an alloy, or a metal oxide. Examples of suitable metals or alloys include, but are not limited to, nickel, stainless steel, titanium, tungsten, and nickel-based alloys. In other embodiments, other carbon supports for the current collector substrate can be used. Such carbon supports include, but are not limited to, carbon nanotube, modified carbon black, activated carbon. In other embodiments, other current collector substrates can be used. Such substrates include, but are not limited to, 3-D structured carbon, porous carbons and nickel metal meshes.

An NEMD powder electrode may be incorporated into the manufacture of a battery (e.g. a Zn/MnO₂ battery). An NEMD powder electrode may be a component of a battery (e.g. a Zn/MnO₂ battery). An NEMD powder electrode may be adapted for use in a battery (e.g. Zn/MnO₂ battery). An NEMD powder electrode may be used in a battery (e.g. Zn/MnO₂ battery).

In other embodiments, polyvinylidene fluoride solutions comprising other wt % of polyvinylidene fluoride can be used. For example, such solutions can contain 1-15 wt % of polyvinylidene fluoride.

In other embodiments, other drying temperatures can be used. For example, the drying temperature can be any temperature between about 80° C. and about 110° C. For example, the drying temperature can be between about 80° C. and about 110° C., 80° C. and about 100° C., 80° C. and about 90° C., 90° C. and about 110° C., 90° C. and about 100° C., about 100° C. and about 110° C. In other embodiments, other drying times can be used. For example, the drying time can be any time between about 1.5 hours and 5 hours. For example, the drying time can be about 5 hours and 18 hours, about 5 hours and 14 hours, about 5 hours and 10 hours, and about 5 hours and about 8 hours.

In other embodiments, the ratio of NEMD powder to carbon black to PVDF can vary. Examples of suitable ratios include, but are not limited to, 7:2:1, 14:3:3, 3:1:1, 6:3:1, 12:5:3.

In other embodiments, other binders and binder solvents can be used. For example, polyvinyl alcohol (PVA) crosslinked with glutaraldehyde can be used as a binder in the form of water solution. Without being bound by theory, it is believed that PVA increases the hydrophilicity of an electrode, thereby improving battery performance. In another example, styrene-butadiene, which is a rubber based binder, can be used. Other binders include, but are not limited to, M-class rubbers and Teflon.

In other embodiments, additives such as, but not limited to, sulfates, hydroxides, alkali salts, alkaline-earth metal salts, transition metal salts, oxides, and hydrates thereof can also be added during the formation of the electrode. Examples of alkaline-earth metal salts and sulfates include, but are not limited to, BaSO₄, CaSO₄, MnSO₄, and SrSO₄. Examples of transition metal salts include, but are not limited to, NiSO₄ and CuSO₄. Examples of oxides include, but are not limited to, Bi₂O₃ and TiO₂. In other embodiments, additives such as, but not limited to, copper-based and bismuth-based additives can also be added in the formation of the electrode. Without being bound by theory, it is believed that such additives improve the cyclability of the battery.

Direct Deposit of Neutral EMD onto a Current Collector to Form an Ex-Situ NEMD Electrode

Neutral EMD may be synthesized and directly deposited onto a current collector to form an electrode comprising the neutral EMD. Such a formed electrode may then be incorporated into a battery. An electrode formed from the direct deposition of neutral EMD thereon that is adapted for incorporation into a battery (i.e. the electrode is produced external to the battery) may be referred to as an “Ex-situ NEMD electrode” in this disclosure.

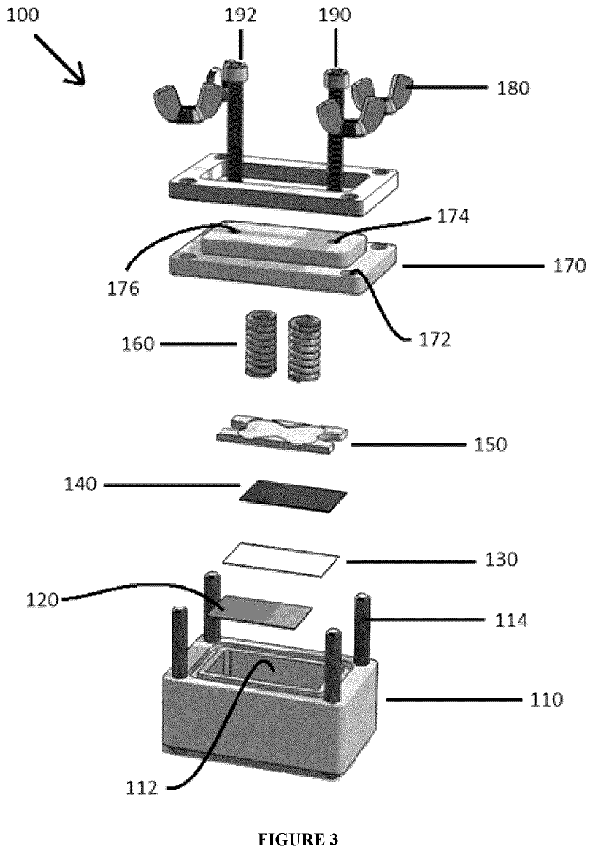

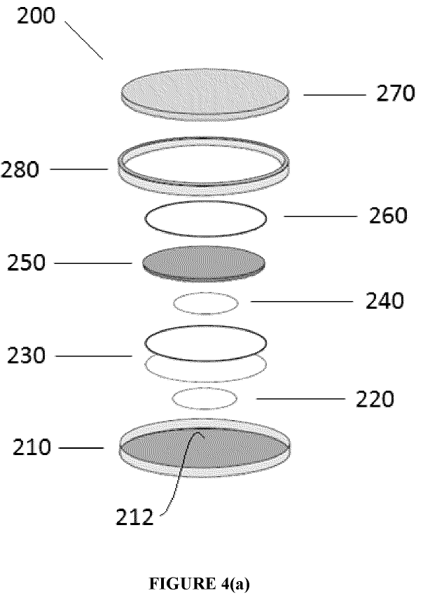

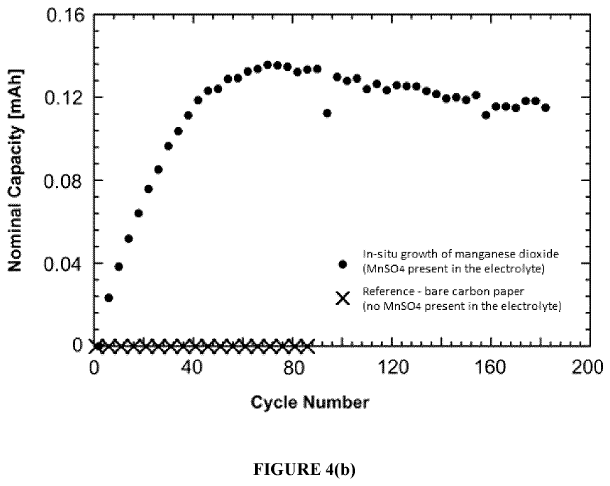

Referring to FIG. 3, and according to a first embodiment of forming an Ex-situ NEMD electrode, a deldrin-based cell 100 is provided. The cell 100 comprises a body 110 and a lid 170 (the lid being depicted as having two parts in FIG. 4). The body 110 has a plurality of walls and a bottom defining an inner cavity 112. A plurality of bolts 114 are arranged around the walls. The lid 170 comprises: (i) a plurality of bores 172 for receiving the bolts 114 therethrough; (ii) a bore 174 for receiving an anode contact 190 therethrough; and (iii) a bore 176 for receiving a cathode contact 192 therethrough. In other embodiments, any other suitable cell can be used.

A cathode 120 comprising a zinc foil (e.g. Dexmet S031050 with a thickness of about 0.5 mm) is disposed in the inner cavity 112 of the deldrin-based cell 100. An electrolytic solution comprising about 2.0M of ZnSO₄.7H₂O and about 0.6M of MnSO₄.H₂O is added into the inner cavity 112 until the cathode 120 is in fluid contact therewith (e.g. immersed therein). The cathode 120 is positioned in the inner cavity 112 of the body 110 in a manner such that cathode contact 192 can be placed in direct contact with cathode 120.

A separator 130 is disposed in the inner cavity 112. The separator 130 has two layers: a first layer and a second layer. Each of the first layer and second layer consists essentially of a sub-layer of cellophane film and a sub-layer of nonwoven polyester fabric (e.g. NWP150 manufactured by Neptco Inc.) coupled thereto. As contemplated in this embodiment, each of the first layer and the second layer has an area of about 2.3 cm×about 4.8 cm. In other embodiments, the first layer and the second layer can have other suitable areas.

The first layer and second layer of the separator 130 are arranged such that the nonwoven polyester fabric sub-layers thereof are adjacent to one another. The separator 130 is disposed on top of the cathode 120 such that the cathode 120 is adjacent to the cellophane film sub-layer of the first layer. The separator 130 has a thickness of about 0.15 mm. The separator 130 is also in fluid contact with (e.g. immersed in) the electrolytic solution. The separator 130 is positioned in the inner cavity 112 of the body 110 in a manner such that cathode electrode contact 192 may be placed in direct contact with cathode 120.

An anode 140 comprising carbon paper (e.g. TGP-H-120 carbon paper with a thickness of about 0.037 mm) is disposed in the inner cavity 112 of the deldrin-based cell 100 such that the anode 140 is adjacent to the cellophane film sub-layer of the second layer of the separator 130. The electrolytic solution is added into the inner cavity 112 until anode 140 is also in fluid contact with (e.g. immersed in) electrolytic solution. The anode 140 is positioned in the inner cavity 112 of the body 110 in a manner such that anode contact 190 can be placed in direct contact with anode 140.

A pressure plate 150 is disposed on top of the anode 140. Compression springs 160 are disposed over the pressure plate 150. Lid 170 is placed over the compression springs 160, and the compression springs 160 are compressed between the pressure plate 150 and the lid 170. Pressure is exerted on the anode 140 and separator 130 and cathode 120 thereunder. Bores 172 receive bolts 114, and the lid 170 is secured in place by threading the nuts 180 onto the bolts 114 until the nuts 180 are in contact with the lid 170. The nuts 180 are tightened until a pressure of about 45 to about 50 PSI is exerted on the pressure plate, and therefore on the anode 140 and separator 130 and cathode 120 thereunder. In other embodiments, other suitable pressures can be exerted against the anode 140 and separator 130 and cathode 120 of the deldrin-based cell 100.

Anode contact 190 is inserted through the bore 174 and is configured to be in direct contact with the anode 140. Cathode contact 192 is inserted through the bore 176 and configured to be in direct contact with the cathode 120. The contacts 190 and 192 are connected, and a potential of about 2.5 V_{cell} or a current of about 0.3 mA cm⁻² is applied between the cathode and anode over a pre-determined period of time (e.g. any period of time between about 18 hours and 48 hours). In other embodiments, a potential between about 1.8 V_{cell} and about 2.5 V_{cell} can be applied between the cathode and the anode. For example, a potential of 1.8 V_{cell}, 1.9 V_{cell}, 2.0 V_{cell}, 2.1 V_{cell}, 2.2 V_{cell}, 2.3 V_{cell}, 2.4 V_{cell}, 2.5 V_{cell}, can be applied between the cathode and the anode. Manganese dioxide synthesis conditions are maintained at room temperature (i.e. between about 20° C. to about 25° C.) over the pre-determined period of time. Neutral EMD is synthesized and is directly deposited onto the anode 140, thereby forming an Ex-situ NEMD electrode.

The Ex-situ NEMD electrode is removed from the cell 100, and undergoes one or more washing steps. For example, the Ex-situ NEMD electrode may be washed 1, 2, 3, 4, 5 or more times with de-ionized water, each time for a period of time of about 1 minute or more.

The washed EMD electrode is then dried at elevated temperatures. Examples of suitable elevated temperature ranges include, but are not limited to, between 50° C. and 90° C., 50° C. and 80° C., 50° C. and 70° C., 50° C. and 60° C., 60° C. and 90° C., 60° C. and 80° C., 60° C. and 70° C., 70° C. and 90° C., 70° C. and 80° C., 80° C. and 90° C. As contemplated in this first embodiment, the washed EMD electrode is dried at temperatures between 70° C. and 80° C.

An Ex-situ electrode may be incorporated into the manufacture of a battery (e.g. a Zn/MnO₂ battery). An Ex-situ electrode may be a component of a battery (e.g. a Zn/MnO₂ battery). An Ex-situ electrode may be adapted for use in a battery (e.g. Zn/MnO₂ battery). An Ex-situ electrode may be used in a battery (e.g. Zn/MnO₂ battery).

In other embodiments, the zinc sulfate heptahydrate is present in the electrolytic solution in any suitable concentration. Non-limiting examples of suitable concentrations include those ranging from about 0.5M to saturation, about 0.5M to about 2.5M, about 1.0M to saturation, about 1.0M to about 2.5M, about 1.5M to saturation, and about 1.5M to about 2.5M. For example, zinc sulfate heptahydrate can be present in solution at a concentration of about 0.5M, 0.6M, 0.7M, 0.8M, 0.9M, 1.0M, 1.1M, 1.2M, 1.3M, 1.4M, 1.5M, 1.6M, 1.7M, 1.8M, 1.9M, 2.0M, 2.1M, 2.2M, 2.3M, 2.4M, 2.5M. In other embodiments, hydrated zinc sulfates dissolved in the electrolytic solution at the same or a similar concentration as above can be used. In other embodiments, the zinc-based salt can be, but is not limited to, zinc nitrate, zinc chloride, zinc triphlate, a combination thereof that is dissolved in the electrolytic solution at a suitable concentration.

In other embodiments, the manganese sulfate monohydrate is present in the electrolytic solution in any suitable concentration. Non-limiting examples of suitable concentrations include those ranging from about 0.1M to about 0.6M, about 0.1M to about 0.3M, about 0.2M to about 0.6M, about 0.2M to about 0.3M, about 0.3M to about 0.6M, about 0.4M to about 0.6M. Non-limiting examples of suitable concentrations include those ranging from about 0.1M to about 0.2M. For example, manganese sulfate monohydrate can be present in the electrolytic solution at a concentration of about 0.21M, 0.22M, 0.23M, 0.24M, 0.25M, 0.26M, 0.27M, 0.28M, 0.29M, 0.30M, 0.31M, 0.32M, 0.33M, 0.34M, 0.35M, 0.36M, 0.37M, 0.38M, 0.39M, 0.40M, 0.41M, 0.42M, 0.43M, 0.44M, 0.45M, 0.46M, 0.47M, 0.48M, 0.49M, 0.50M, 0.51M, 0.52M, 0.53M, 0.54M, 0.55M, 0.56M, 0.57M, 0.58M, 0.59M, and 0.60M. For example, manganese sulfate monohydrate can be present in the electrolytic solution at a concentration of about 0.10M, 0.11M, 0.12M, 0.13M 0.14M, 0.15M, 0.16M, 0.17M, 0.18M, 0.19M, 0.20M. In other embodiments, other hydrated manganese sulfates or non-hydrated manganese sulfate dissolved in the electrolytic solution at the same or a similar concentration as above can be used. In other embodiments, the electrolytic solution comprises another suitable manganese species that has the same or substantially similar function as manganese sulfate monohydrate.

In other embodiments, the electrolytic solution further comprises a suitable pH buffer system that is present at a suitable concentration in the electrolytic solution. For example, suitable concentrations include, but are not limited to, concentration ranges between and about 0.05M and about 0.20M, about 0.05M and about 0.20M, about 0.05M and about 0.15M, about 0.06M and about 0.19M, about 0.07M and about 0.18M, about 0.08M and about 0.17M, and about 0.09M and about 0.16M. For example, suitable concentrations include, but are not limited to, about 0.05M, 0.06M, 0.07M, 0.08M, 0.09M, 0.10M, 0.11M, 0.12M, 0.13M, 0.14M, 0.15M, 0.16M, 0.17M, 0.18M, 0.19M, 0.20M. Non-limiting examples of suitable pH buffer systems include acetates, sulfates, phosphates, and combinations thereof. A non-limiting example of a suitable buffer system is one that comprises Mn(CH₃COO)₂ and Na₂SO₄ each dissolved in the electrolytic solution at a concentration of about 0.1M.

In other embodiments, any suitable pH buffer system that maintains the pH of the electrolytic solution between about 3 and about 7 can be used. Suitable pH buffer systems include, but are not limited to, citrates, phosphates, and combinations thereof. In other embodiments, any suitable pH buffer system that maintains the pH of the electrolytic solution between about 0 and about 7 can be used. In other embodiments, any suitable pH buffer system that maintains the pH of the electrolytic solution between about 7 and about 9 can be used.

In other embodiments, the cathode can be any suitable material including, but not limited to, nickel metal foil, platinum metal foil, copper based materials, and indium tin based materials.

In other embodiments, the separator can be a single layer consisting essentially of a sub-layer of cellophane film and a sub-layer of nonwoven polyester fabric. In other embodiments, the separator can be an ion conducting membrane such as, but not limited to, a cation exchange membrane and an anion exchange membrane. In other embodiments, the separator can be any suitable separator that is known in the art.

In other embodiments, the anode comprises a nickel metal foil (e.g. MF-NiFoil-25u produced by MTI Corporation) of a suitable width, height, and thickness. For example, the anode can be 4 cm wide, 14 cm high, and 0.04 mm thick. In other embodiments, the anode comprises another suitable current collecting material, possesses other specific physical characteristics, or both. Examples of other suitable current collecting materials of other specific physical characteristics include, but are not limited to, metal foams, carbon papers, porous carbon, gas diffusion layers, and 3-D structured carbon. Examples of metal foams include, but are not limited to, nickel foams. With reference to porous anodes (including foam materials), and without being bound by theory, it is believed that the high surface area of porous anodes provide sites for synthesized neutral EMD to attach.

In other embodiments, the anode (e.g. a carbon-based anode or metal mesh anode) can be coated with an additional carbonaceous layer (e.g. an activated carbon, vulcanized, graphene, or carbon nano-tube). Without being bound by theory, it is believed that such additional coating enhances the electro-deposition of manganese dioxide onto the anode during electrolysis. In other embodiments, the anode (e.g. a carbon-based anode) can be pre-treated. Pre-treatment of the anode can include heat treatment of the cathode at elevated temperatures (e.g. 500-900° C.) in a mixture of ammonia and a carrier gas (e.g. Ar₂, He₂, or N₂). Without being bound by theory, it is believed that pre-treatment of the anode oxidizes the surface of the anode and improves the rate of deposition of manganese dioxide onto the anode during electrolysis. Without being bound by theory, it is believed that pre-treatment of the anode increases hydrophilicity of the electrode. A battery incorporating an electrode that has undergone the foregoing pre-treatment may experience improved battery performance over a battery incorporating an electrode that has not undergone the foregoing pre-treatment.

In other embodiments, the anode onto which neutral EMD is deposited is coated in a coating such as, but not limited to, a carbon black layer. For example, a carbon black layer can be coated onto a carbon current collector substrate (e.g. carbon paper anode). Without being bound by theory, it is believed that a carbon black layer coating on a carbon current collector substrate increases the battery specific capacity (in mAh) during the formation of neutral EMD on the anode. The characteristics of the carbon black layer can be manipulated to achieve a desired effect. For example, the carbon black layer can have a low surface area or a high surface area (e.g. Black Pearls 2000), a particular 3-D lattice structure, or impregnate into the anode at varying depths. It is believed that such modifications to the coating layer, coupled with variations in the characteristics of the anode itself, may allow a manufacturer to manipulate the specific energy capacity of a battery.

In other embodiments, additives such as, but not limited to, sulfates, hydroxides, alkali salts, alkaline-earth metal salts, transition metal salts, oxides, and hydrates thereof can also be added during the formation of the electrode comprising neutral EMD (e.g. Ex-situ NEMD electrode). Examples of alkaline-earth metal salts and sulfate species include, but are not limited to, BaSO₄, CaSO₄, MnSO₄, and SrSO₄. Examples of transition metal salts include, but are not limited to, NiSO₄ and CuSO₄. Examples of oxides include, but are not limited to, Bi₂O₃ and TiO₂. In other embodiments, additives such as, but not limited to, copper-based and bismuth-based additives can also be added in the formation of the electrode. Without being bound by theory, it is believed that such additives improve the cyclability of a battery.

In other embodiments, other compression means known in the art can be used. For example, compression means comprising compressed air pressure, such as a pneumatic air bladder, may be used.

In other embodiments, the synthesis occurs at any other suitable temperature other than room temperature including, but not limited to, temperature ranges between about 10° C. and 19° C., about 26° C. to 35° C., about 36° C. to 45° C., about 46° C. to 55° C., and about 56° C. to 65° C.

In other embodiments, the pressure that is applied to the anode 140 and separator 130 and cathode 120 thereunder can be any suitable pressure. For example, the applied pressure can be, but is not limited to, one that is between about 10 PSI and about 170 PSI, about 50 PSI and about 160 PSI, about 50 PSI and about 150 PSI, about 50 PSI and about 140 PSI, about 50 PSI and about 130 PSI, about 50 PSI and about 120 PSI, about 50 PSI and about 110 PSI, about 50 PSI and about 100 PSI, about 50 PSI and about 90 PSI, about 50 PSI and about 80 PSI, about 50 PSI and about 70 PSI, and about 50 PSI and about 60 PSI. For example, the applied pressure can be, but is not limited to, about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100, 101, 102, 103, 104, 105, 106, 107, 108, 109, 110 PSI. Without being bound by theory, it is believed that a battery comprising an Ex-situ NEMD electrode, wherein the Ex-situ NEMD electrode is produced under pressure, may have greater energy density than a battery comprising an EMD electrode that is commercially available. In other embodiments, only atmospheric pressure is applied to the cathode 140 and separator 130 and anode 120.

It is believed that Ex-situ NEMD electrodes require less graphite powders, binders, and ink coatings than electrodes comprising or formed from commercially available EMD powder during their respective manufacturing processes, thereby potentially resulting in lower production costs.

Direct Deposit of Neutral EMD onto a Current Collector to Form an In-Situ NEMD Electrode

Neutral EMD may be synthesized and directly deposited onto a current collector to form an electrode comprising the neutral EMD. Such an electrode may be formed in-situ of a cell that may be used directly as a battery. Such an electrode may be referred to as an “In-situ NEMD electrode” in this disclosure.

Referring to FIG. 4(a), and according to a first embodiment of preparing an In-situ NEMD electrode, a coin cell 200 is provided. The coin cell 200 comprises an outer casing 210 and a lid 270 that are made of stainless steel (e.g. CR2032 manufactured from MTI Corporation). The outer casing 210 has a base and a sidewall circumscribing the base. The sidewall and the base define an inner cavity 212. The coin cell 200 has a diameter of about 20 mm. The coin cell 200 also comprises a gasket 280 (e.g. O-ring) made of a suitable elastomeric material (e.g. polypropylene), a spacer 250, and a washer 260. The coin cell also comprises a cathode 240, an anode 220, and a separator 230 in between the cathode 240 and the anode 220, all in fluid contact with (e.g. immersed in) an electrolytic solution. In other embodiments, any other suitable cell can be used.

The anode 220 is disposed within the inner cavity 212 of the coin cell 200. As contemplated in this embodiment, the anode 220 is a piece of carbon paper (e.g. TGP-H-120 with a thickness of about 0.037 mm) having a diameter of about 15 mm. In other embodiments, other suitable dimensions can be provided. An electrolytic solution comprising about 2.0M of ZnSO₄.7H₂O (e.g. 98% purity from Anachemia Canada Co.) and about 0.1M of MnSO₄.H₂O (e.g. 99% purity from Anachemia Canada Co.) is added into the inner cavity 212 of the coin cell 200 until the cathode 220 is in fluid contact with (e.g. immersed in) the electrolytic solution.

The separator 230 is also disposed in the coin cell 200. The separator 230 has two layers: a first layer and a second layer. As contemplated in this first embodiment, each of the first layer and second layer consists essentially of a sub-layer of cellophane film and a sub-layer of nonwoven polyester fabric (e.g. NWP150 manufactured by Neptco Inc.) coupled thereto. Also, each of the first layer and second layer has a diameter of about 17 mm. The first layer and second layer are arranged such that the nonwoven polyester fabric sub-layers thereof are adjacent to one another. The separator 230 is disposed on top of the anode 220 such that the anode 220 is adjacent to the cellophane film sub-layer of the first layer. The separator 230 has a thickness of about 0.15 mm. The separator 230 is in fluid contact with (e.g. immersed in) the electrolytic solution.

The cathode 240 comprises a zinc foil (e.g. Dexmet S031050 with a thickness of about 0.5 mm) and is disposed in the coin cell 200 such that the anode 240 is adjacent to the cellophane film sub-layer of the second layer of the separator. The electrolytic solution is added to the coin cell 200 until the cathode 240 is also in fluid contact with (e.g. immersed in) the electrolytic solution. As contemplated in this embodiment, the cathode 240 has a diameter of about 15 mm. In other embodiments, other suitable dimensions can be provided.

The spacer 250 is placed adjacent to the cathode 240, the washer 260 is placed adjacent to the spacer 250, and the gasket 280 is placed adjacent to the washer 260. The spacer 250 and the washer 260 are made of stainless steel. The outer lid 270 is placed over the gasket 280, and the outer lid 270 and outer casing 210 are crimped together to form the coin cell 200.

To synthesize an In-situ NEMD electrode, the coin cell 200 is galvanostatically charged at 0.1 mA cm⁻² up to 1.85 V_{cell} and then maintained at 1.85 V_{cell} for about 2 or more hours (e.g. 3 hours). The coin cell 200 is then discharged at 0.1 mA cm⁻² to 0.9 V_{cell}. At that point, the coin cell 200 is galvanostatically charged at 0.1 mA cm⁻² back up to 1.85 V_{cell} ii. Charging and discharging of the coin cell 200 to the above stated V_{cell} and at the above stated mA cm⁻² leads to the deposition of neutral EMD on the anode and therefore the in situ formation of an In-situ NEMD electrode in the coin cell 200. Referring to FIG. 4(b), specific capacity of the cell increases over the first 80 or so cycles owing to the growing deposition of neutral EMD onto the anode (see plot with black circular dots). A slight reduction in specific capacity was observed beyond 80 or so cycles. The foregoing observation is compared against a reference cell that does not comprise manganese sulfate in its electrolytic solution (see plot with “x”s in FIG. 4(b)). As noted in FIG. 4(b) for that reference cell, no increase in specific capacity of the cell was observed over cycling. The electrolytic synthesis process is performed at room temperature (i.e. about 20° C. to about 25° C.).

The coin cell 200 comprising an In-situ NEMD electrode may be used directly as a battery. It is believed that a battery comprising an In-situ NEMD electrode simplifies battery preparation procedures.

In other embodiments, the outer casing of the coin cell is made of any suitable material. In other embodiments, the diameter of the coin cell may be any suitable diameter as applicable to industry standards for battery sizes. In other embodiments, the spacer is made of any suitable material. In other embodiments, the washer is made of any suitable material including, but not limited to, polypropylene.

In other embodiments, the zinc sulfate heptahydrate in the electrolytic solution is of any suitable concentration. Non-limiting examples of suitable concentrations include those ranging from about 0.5M to saturation, about 0.5M to about 2.5M, about 1.0M to saturation, about 1.0M to about 2.5M, about 1.5M to saturation, and about 1.5M to about 2.5M. For example, zinc sulfate heptahydrate can be present in solution at a concentration of about 0.5M, 0.6M, 0.7M, 0.8M, 0.9M, 1.0M, 1.1M, 1.2M, 1.3M, 1.4M, 1.5M, 1.6M, 1.7M, 1.8M, 1.9M, 2.0M, 2.1M, 2.2M, 2.3M, 2.4M, 2.5M. In other embodiments, other hydrated zinc sulfates or non-hydrated zinc sulfate dissolved in the electrolytic solution at the same or a similar concentration as above can be used. In other embodiments, the zinc-based salt can be, but is not limited to, zinc nitrate, zinc chloride, zinc triphlate, or a combination thereof dissolved in the electrolytic solution at a suitable concentration.

In other embodiments, the manganese sulfate monohydrate in the electrolytic solution is present in any suitable concentration. Suitable concentrations include those ranging from about 0.1M to about 0.2M. For example, manganese sulfate monohydrate can be present in the electrolytic solution at a concentration of about 0.10M, 0.11M, 0.12M, 0.13M 0.14M, 0.15M, 0.16M, 0.17M, 0.18M, 0.19M, 0.20M. In other embodiments, the concentration of manganese sulfate monohydrate in the electrolytic solution is brought to saturation. Without being bound by theory, it is believed that additional manganese sulfate may hinder at least in part any reverse-reaction that formed manganese dioxide may participate in during the charging cycle, and may improve the cyclability of the produced battery. In other embodiments, other hydrated manganese sulfates or non-hydrated manganese sulfate dissolved in the electrolytic solution at the same or a similar concentration as above can be used. In other embodiments, the electrolytic solution comprises another suitable manganese species that has the same or substantially similar function as manganese sulfate monohydrate such as, but not limited to, manganese nitrate.

In other embodiments, the electrolytic solution further comprises a suitable pH buffer system present at a suitable concentration. For example, suitable concentrations include, but are not limited to, concentration ranges between and about 0.01M and about 0.30M, about 0.01M and about 0.20M, about 0.01M and about 0.15M, about 0.02M and about 0.29M, about 0.03M and about 0.27M, about 0.04M and about 0.26M, about 0.05M and about 0.25M, about 0.05M and about 0.20M, about 0.05M and about 0.15M, about 0.06M and about 0.24M, about 0.07M and about 0.23M, about 0.08M and about 0.22M, and about 0.09M and about 0.21M. For example, suitable concentrations include, but are not limited to, about 0.01M, 0.02M, 0.03M, 0.04M, 0.05M, 0.06M, 0.07M, 0.08M, 0.09M, 0.10M, 0.11M, 0.12M, 0.13M, 0.14M, 0.15M, 0.16M, 0.17M, 0.18M, 0.19M, 0.20M, 0.21M, 0.22M, 0.23M, 0.24M, 0.25M, 0.26M, 0.27M, 0.28M, 0.29M, and 0.30M. In some embodiments, the concentration ranges between about 0.05M and about 0.20M (e.g. 0.05M and 0.20M). Non-limiting examples of suitable pH buffer systems include those selected from acetates, sulfates, phosphates, and combinations thereof. An example of a suitable buffer system is one that comprises Mn(CH₃COO)₂ and Na₂SO₄ each dissolved in the electrolytic solution to a concentration of about 0.1M.

In other embodiments, the cathode can be any suitable electrode including, but not limited to, nickel metal foil and platinum metal foil.

In other embodiments, the separator is a microporous separator. In other embodiments, the separator can be a single layer consisting essentially of a sub-layer of cellophane film and a sub-layer of nonwoven polyester fabric. In other embodiments, the separator can be an ion conducting membrane such as, but not limited to, a cation exchange membrane and an anion exchange membrane. In other embodiments, the separator can be any suitable separator known in the art.

In other embodiments, the anode comprises a nickel metal foil (e.g. MF-NiFoil-25u produced by MTI Corporation) of a suitable width, height, and thickness. For example, the anode can be 4 cm wide, 14 cm high, and 0.04 mm thick. In other embodiments, the anode comprises another suitable current collecting material, possesses other specific physical characteristics, or both. Examples of other suitable current collecting materials of other specific physical characteristics include, but are not limited to, metal foams, carbon papers, porous carbon, gas diffusion layers, and 3-D structured carbon. Examples of metal foams include, but are not limited to, nickel foams, stainless steel, steel wool, and tungsten foam.

In other embodiments, the anode (e.g. a carbon-based anode) can be pre-treated. Pre-treatment of the anode can include heat treatment of the anode at elevated temperatures (e.g. 500-900° C.) in a mixture of ammonia and a carrier gas (e.g. Ar₂, He₂, or N₂).

In other embodiments, the anode onto which the neutral EMD deposits is coated in a coating such as, but not limited to, a carbon black layer. For example, a carbon black layer can be coated onto a carbon current collector substrate (e.g. carbon paper cathode). The characteristics of the carbon black layer can be manipulated to achieve a desired effect. For example, the carbon black layer can have a low surface area or a high surface area (e.g. Black Pearls 2000), a particular 3-D lattice structure, or impregnate into the anode at varying depths.

In other embodiments, the electrolytic solution further comprises one or more chemical additives. Examples of chemical additives include, but are not limited to, alkali salts, alkaline-earth metal salts, transition metal salts, oxides, and hydrates thereof. Examples of alkaline earth metal salts include, but are not limited to, BaSO₄, CaSO₄, and SrSO₄. Examples of transition metal salts include, but are not limited to, NiSO₄ and CuSO₄. Examples of oxides include, but are not limited to, Bi₂O₃ and TiO₂. Without being bound by theory, it is believed that one or more chemical additives may improve the cyclability of the battery.

In other embodiments, the synthesis occurs at any other suitable temperature other than room temperature including, but not limited to, temperature ranges between about 10° C. and 19° C., about 26° C. to 35° C., about 36° C. to 45° C., about 46° C. to 55° C., and about 56° C. to 65° C.

In other embodiments, any suitable pressure known in the art may be applied to the anode, separator, and cathode. The applied pressure can be, but is not limited to, one that is between about 10 PSI and about 170 PSI, about 50 PSI and about 170 PSI, about 50 PSI and about 160 PSI, about 50 PSI and about 150 PSI, about 50 PSI and about 140 PSI, about 50 PSI and about 130 PSI, about 50 PSI and about 120 PSI, about 50 PSI and about 110 PSI, about 50 PSI and about 100 PSI, about 50 PSI and about 90 PSI, about 50 PSI and about 80 PSI, about 50 PSI and about 70 PSI, and about 50 PSI and about 60 PSI. For example, the applied pressure can be, but is not limited to, about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100 PSI. In other embodiments, only atmospheric pressure is applied to the cathode, separator, and anode.

In other embodiments, no voltage cutoff in the charging step of battery charge/discharge cycling is present. For example, the coin cell may be galvanostatically charged at 0.1 mA cm⁻² to beyond 1.85 V_{cell} (e.g. 2 V_{cell} or beyond). It is believed that cycling without a charge voltage cut-off leads to faster deposition of neutral EMD onto the anode, and also increased loading of the neutral EMD onto the anode (e.g. 8 mg/cm²). In other embodiments, the coin cell is galvanostatically charged at 0.1 mA cm⁻² to between about 1.75 and about 2.0 V_{cell}, and maintained in that voltage range for about 2 or more hours.

It is believed that In-situ NEMD electrodes require less graphite powders, binders, and ink coatings than electrodes comprising or formed from commercially available EMD powder during their respective manufacturing processes, thereby potentially resulting in lower production costs.

### Battery Characterization

This disclosure further relates to a battery comprising: (i) an electrode, the electrode comprising neutral EMD; (ii) an anode; (iii) a separator between the anode and the cathode; and (iv) an electrolytic solution with which the cathode, the anode, and the separator are in fluid contact. Such battery may be referred to as an “NEMD Battery” in this disclosure.

The electrode comprising neutral EMD may be an NEMD powder electrode, Ex-situ NEMD electrode, or an In-situ NEMD electrode. The electrode comprising neutral EMD serves as the cathode of the battery.

The anode of the battery can be a metal foil such as, but not limited to, zinc foil (e.g. Dexmet S031050), nickel metal foil, and platinum metal foil. In other embodiments, the anode can be formed from zinc/zinc oxide powder mixed with binder (e.g. Teflon). In other embodiments, the anode can include additives such as, but not limited to, indium sulfate. Without being bound by theory, it is believed that indium sulfate reduces hydrogen evolution at the anode.

The separator can be any separator as described above.

The electrolytic solution can be any electrolytic solution described above (see for example, the electrolytic solution as described in the heading entitled “Direct Deposit of Neutral EMD onto a current collector to form an In-situ NEMD electrode”). In an embodiment, the electrolytic solution comprises between 0.1M and 0.2M MnSO₄.H₂O.

In another embodiment, the battery is the cell described in the heading entitled “Direct Deposit of Neutral EMD onto a current collector to form an In-situ NEMD electrode” upon synthesis of the In-situ NEMD electrode, wherein the In-situ NEMD electrode serves as the cathode of the battery, and the cathode of the cell serves as the anode of the battery.

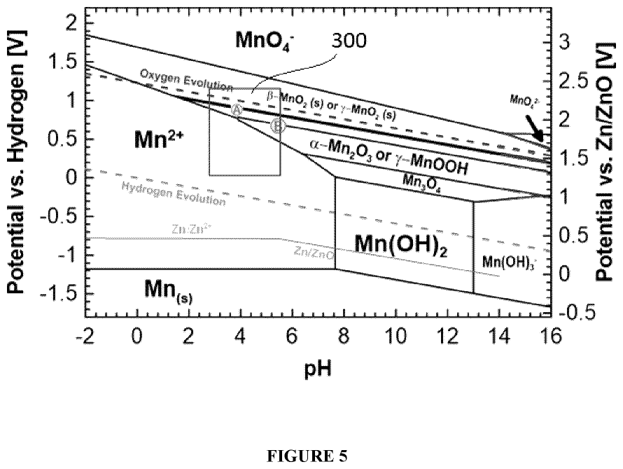

The performance of a battery comprising an electrode comprising neutral EMD may also depend on the operating conditions of the battery. Referring to FIG. 5, a Pourbaix Diagram is provided, the Pourbaix Diagram depicting general operating conditions 300 (as defined by potential and pH conditions) of a battery comprising an electrode comprising neutral EMD. For example, operation conditions of a battery may include maintaining the pH of the battery between about 3.9 and about 5.4 during operation. For example, operation conditions of a battery may include maintaining the voltage of the battery between about 1.1 V and about 1.9 V during operation. In other embodiments, other operating conditions may be present or possible. For example, in other embodiments, the operation conditions of a battery may be maintained at any pH between about 2.0 and about 6.5.

### Example 1

Batteries comprising: (i) an electrode formed from EMD that is currently commercially available; (ii) an NEMD powder electrode; or (iii) an Ex-situ NEMD electrode; are compared against each other under the “voltage cut-off discharge” protocol. In this protocol, cells are discharged with constant current (galvanostatic discharge) until a specified lower cutoff voltage is reached. Cells are then immediately charged (galvanostatic charged) with the same current until an upper cutoff voltage is reached. The cells are then held at the same upper cutoff voltage (potentiostatic charge) for a period of time for further charging.

Example test conditions of the voltage cut-off discharge mode include galvanostatically discharging the battery at a C/2 rate down to 1.0 V_{cell}, galvanostatically charging the battery at a C/2 rate up to 1.85 V_{cell}, and maintaining the potentiostatic charge of the battery at 1.85 V_{cell} for two hours. The discharging and charging cycles are repeated. Table 2 below provides a list of the batteries tested under these test conditions:

TABLE 2

| | | | | MnO₂ |
|---|---|---|---|---|
| | EMD Type | | | loading |
| | (refer to | | Cathode | (mg |
| Cell ID | Table 1) | Electrolyte | type | cm⁻²) |
| SZA015_01 | ISA019_05 | 2M ZnSO₄ | Ex-situ NEMD | 1.4 |
| SZA015_04 | SZA015_02 | 2M ZnSO₄ | Ex-situ NEMD | 1.0 |
| NiZnAc | NiZnAc | 2M ZnSO₄ | NEMD powder | 1.9 |
| | | 0.1M MnSO₄ | | |
| SZA010_02 | SZA009_02 | 2M ZnSO₄ | Ex-situ NEMD | 2.4 |
| SZA039_03 | ISA019_01 | 2M ZnSO₄ | NEMD powder | 2.5 |
| | | 0.1M MnSO₄ | | |
| SZA039_05 | ISA019_01 | 1M ZnSO₄ | NEMD powder | 2.4 |
| | | 0.5M Na₂SO₄ | | |
| SZA052_02 | Erachem | 2M ZnSO₄ | Commercial | 2.4 |
| | | | EMD powder | |

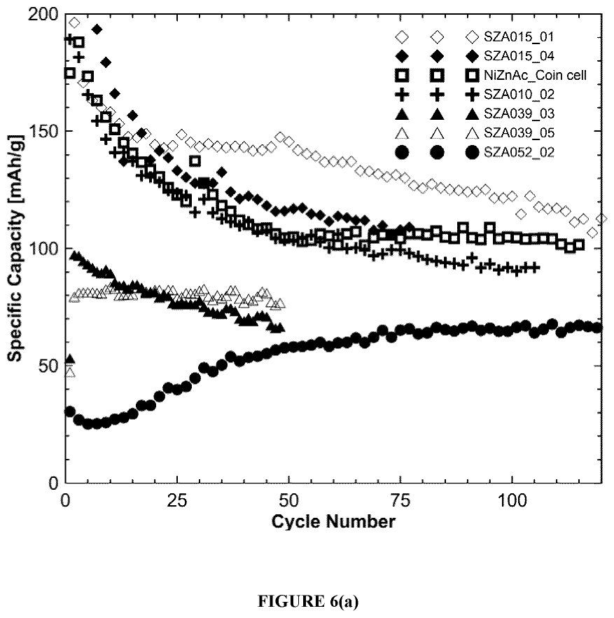

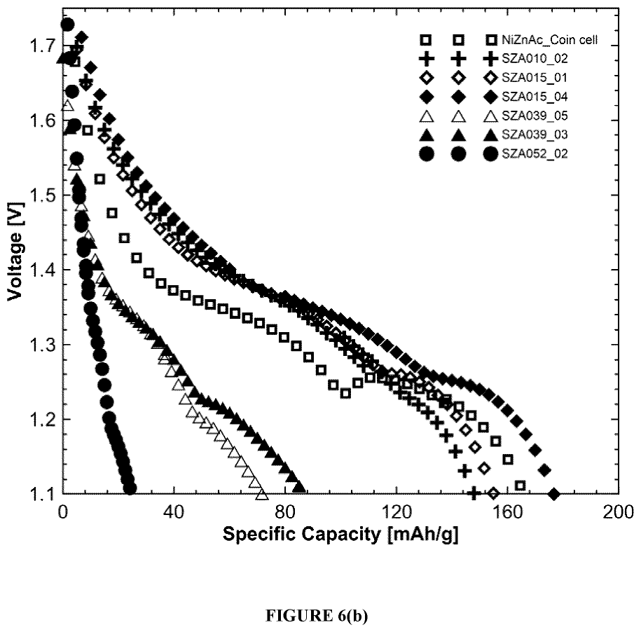

Referring to FIG. 6(a), the initial capacities of the batteries in Table 2, as determined through the above testing procedure, are provided. As can be seen in FIG. 6(a), the battery comprising an electrode formed from EMD that is currently commercially available (i.e. Erachem) has an initial capacity that is relatively low (i.e. less than 50 mAh/g). While the capacity of the battery comprising an electrode formed from EMD that is currently commercially available increases with cycling, the capacity does not exceed 100 mAh/g during testing. On the other hand, batteries comprising an NEMD powder electrode or an Ex-situ NEMD electrode, in general, exhibit higher capacities during testing than batteries comprising an electrode formed from EMD that is currently commercially available. Referring to the batteries comprising an NEMD powder electrode or an Ex-situ NEMD electrode and disclosed in Table 2, initial capacities of greater than 100 mAh/g are achievable. Referring to the batteries comprising an NEMD powder electrode or an Ex-situ NEMD electrode and disclosed in Table 2, capacities of greater than 100 mAh/g, sustained over 100 or more cycles under the above experimental conditions, are achievable.

Referring to FIG. 6(b), the voltage/capacity profiles of the batteries in Table 2 after the fifth discharge are provided. As shown, the initial capacity of the battery comprising an electrode formed from EMD that is currently commercially available is lower than batteries comprising an NEMD powder electrode or an Ex-situ NEMD electrode.

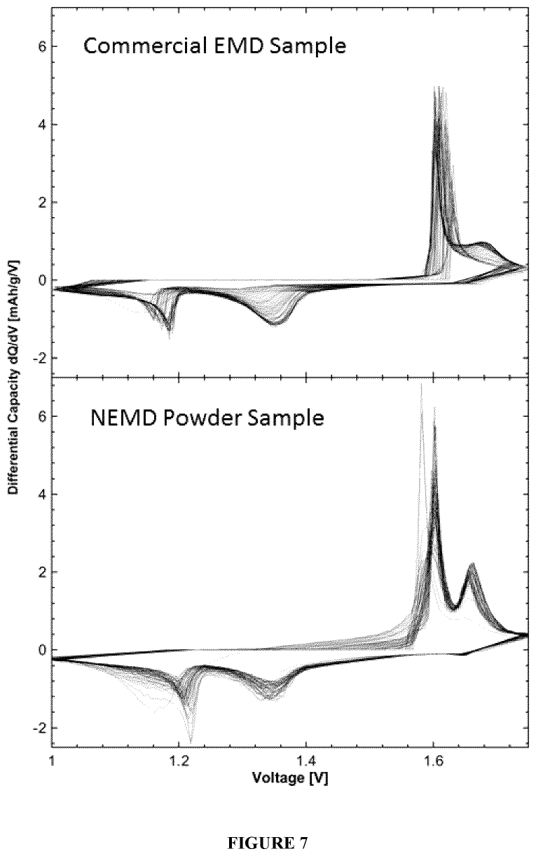

Referring to FIG. 7, dQ/dV plots (i.e. inverse derivatives of voltage-capacity plots) of a commercial EMD sample (i.e. Erachem) and an NEMD powder sample (i.e. Cell ID SZA039_03) are provided. Peaks in dQ/dV plots correspond to plateaus or plateau-like features in the voltage-capacity plots. The area under the dQ/dV plots correspond to the discharge (or charge) capacity delivered in the voltage range corresponding to the peak. The peak position corresponds to the energetics of the reduction (i.e. discharge step) or oxidation (i.e. charge step) processes during battery cycling. Of note, a second peak in the charge process (i.e. in between 1.64 V and 1.68 V) for all batteries comprising an Ex-situ NEMD electrode or an NEMD powder electrode is larger and more well defined than a second peak of the charge process (i.e. in between 1.64 V and 1.68 V) for batteries comprising an electrode formed from commercial EMD (e.g. Cell ID SZA052_02).

### Example 2

Batteries comprising an Ex-situ NEMD electrode and batteries comprising an NEMD powder electrode are compared against each other under the “constant current cut-off discharge” protocol described as follows. In this protocol, the constant current discharge step is terminated when a capacity of 100 mAh g⁻¹ is reached. This capacity is generally obtained before the cell voltage reaches a value of 1.1 V (used in protocol #1). 100 mAh g⁻¹ is selected to reflect industrial target. However, other capacities can be evaluated in other experimental testing.

Test conditions of the constant capacity cut-off discharge mode include galvanostatically discharging the battery at a C/2 rate down to a voltage of 1.1 V_{cell} or a capacity of 100 mAh g⁻¹, galvanostatically charging the battery at a C/2 rate up to 1.75 V_{cell}, maintaining the potentiostatic charge of the battery at 1.75 V_{cell} for two hours, galvanostatically charging the battery at a C/2 rate up to 1.9 V_{cell}, and maintaining the potentiostatic charge of the battery at 1.9 V_{cell} for one hour. Table 3 below provides a list of the batteries tested under these test conditions:

TABLE 3

| | EMD Type | | | MnO₂ |
|---|---|---|---|---|
| | (with | | | loading |
| | reference to | | Cathode | (mg |
| Cell ID | Table 1) | Electrolyte | type | cm⁻²) |
| SZA042_01 | ISA019_05 | 2M ZnSO₄ | NEMD | 2.2 |
| | | | powder | |
| FCB031_03 | SZA047_04 | 2M ZnSO₄ | Ex-situ NEMD | 2.4 |
| | | 0.1M MnSO₄ | | |
| FCB043_03 | ISA019_05 | 2M ZnSO₄ | NEMD powder | 2.7 |
| | | 0.1M MnSO₄ | | |
| SZA052_02 | Erachem | 2M ZnSO₄ | Commercial | 2.4 |
| | | | EMD powder | |

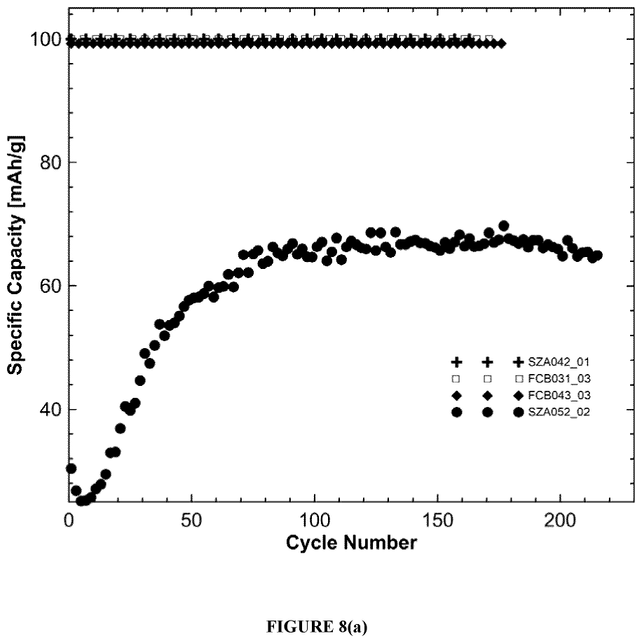

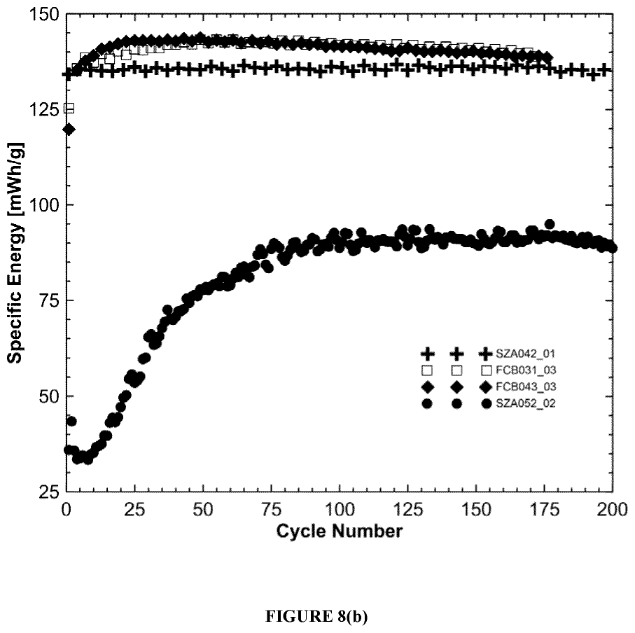

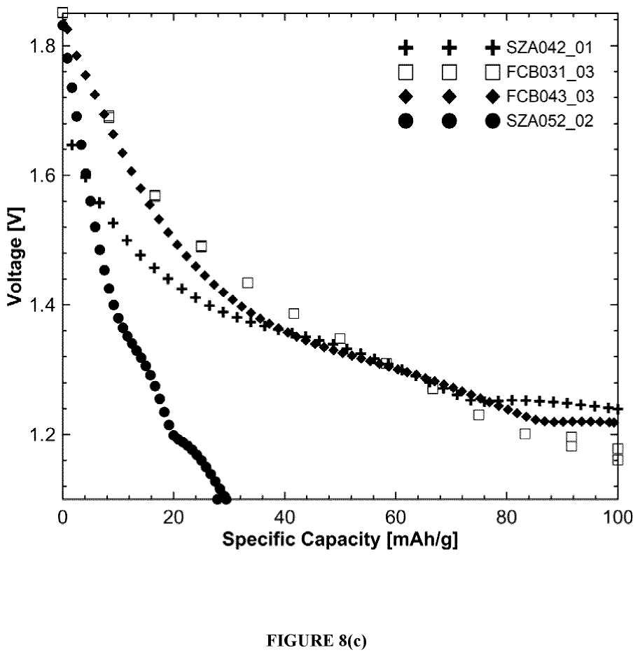

Referring to FIG. 8(a), the initial capacities of the batteries in Table 3, as determined through the above testing procedure, are provided. As can be seen in FIG. 8(a), the battery comprising an electrode formed from EMD that is commercially available (e.g. Cell ID SZA052_02) does not deliver 100 mAh/g by the time the 1.1 V cutoff is reached. The capacity of such batteries comprising an electrode formed from EMD that is commercially available (e.g. Erachem) grows during cycling and eventually stabilizes, but does not reach 100 mAh/g under the testing conditions of this example. On the other hand, batteries incorporating an Ex-situ NEMD electrode or an NEMD powder electrode deliver at least 100 mAh/g before the cut-off voltage of 1.1 V, and maintain their capacity of at least 100 mAh/g for over 100 cycles (e.g. over 150 cycles) under the testing conditions of this example.

Referring to FIG. 8(b), an integrated voltage-capacity (i.e. specific energy as a function of cycling) plot of the batteries provided in Table 3 is provided. As depicted in FIG. 8(b), batteries comprising an NEMD powder electrode or an Ex-situ NEMD electrode maintain a steady energy density of about 135 mWh/g for over 100 cycles (e.g. over 150 cycles, over 175 cycles). On the other hand, the energy density of batteries comprising an electrode formed from EMD that is currently commercially available (e.g. Cell ID SZA052_02) initially increases before stabilizing at around 70 mWh/g after over 100 cycles (e.g. over 150 cycles, over 175 cycles).

Referring to FIG. 8(c), the voltage/capacity profiles of the batteries in Table 3 after the fifth discharge are provided. As shown, the voltage/capacity profiles of the batteries comprising NEMD remain above about 1.2 V, and the energy delivered therefrom remains generally constant. The battery comprising EMD that is currently commercially available (e.g. Cell ID SZA05202) does not exhibit the same properties.

### Example 3

Further examples of batteries comprising an Ex-situ EMD electrode or NEMD powder are provided in Table 4 as follows:

TABLE 4

| | NEMD | Cathode | Cathode | | | |
|---|---|---|---|---|---|---|
| ID | Type | Mixture | Substrate | Anode | Electrolyte | Charging |
| SZA010_02 | Ex-Situ | — | Toray | Zn-foil | 2M ZnSO₄ | galvanostatic to |
| | | | | | | 1.85 V, 1.85 V for 2 h |
| SZA015_01 | Ex-Situ | — | Toray | Zn-foil | 2M ZnSO₄ | galvanostatic to |
| | | | | | | 1.85 V, 1.85 V for 2 h |
| SZA015_04 | Ex-Situ | — | Toray | Zn-foil | 2M ZnSO₄ | galvanostatic to |
| | | | | | | 1.85 V, 1.85 V for 2h |
| NiZnAc | Powder | NEMD/C/PVDF | Toray | Zn-foil | 2M ZnSO₄, 0.1M | galvanostatic to |
| | | (70/20/10) | | | MnSO₄ | 1.85 V, 1.85 V for 2 h |
| SZA039_03 | Powder | NEMD/C/PVDF | Toray | Zn-foil | 2M ZnSO₄, 0.1M | galvanostatic to |
| | | (70/20/10) | | | MnSO₄ | 1.75 V, 1.75 V for 2 h |
| SZA039_05 | Powder | NEMD/C/PVDF | Toray | Zn-foil | 1M ZnSO₄, 0.5M | galvanostatic to |
| | | (70/20/10) | | | Na₂SO₄ | 1.75 V, 1.75 V for 3 h |
| SZA042_01 | powder | NEMD/C/PVDF | Toray | Zn-foil | 2M ZnSO₄ | galvanostatic to |
| | | (70/20/10) | | | | 1.75 V, 1.75 V for 3 h |
| FCB031_03 | Ex-situ | — | Toray | Zn-foil | 2M ZnSO4, 0.1M | 1.75 V for 2h, |
| | | | | | MnSO₄ | galvanostatic |
| | | | | | | to 1.9 V, 1.9 V for 1 h |
| SZA052_02 | Powder | NEMD/C/PVDF | Toray | Zn-foil | 2M ZnSO₄ | 1.75 V for 2 h, |
| | | (70/20/10) | | | | galvanostatic |
| | | | | | | to 1.9 V, 1.9 V for 1 h |
| FCB043_03 | Powder | NEMD/C/PVDF | Toray | Zn-foil | 2M ZnSO₄, 0.1M | 1.75 V for 2 h, |
| | | (70/20/10) | | | MnSO₄ | galvanostatic |
| | | | | | | to 1.9 V, 1.9 V for 1 h |
| FNB115_02 | Powder | NEMD/C/PVDF | Toray | Zn-foil | 2M ZnSO₄, 0.1M | 1 V |
| | | (70/20/10)) | | | MnSO₄ | |

### Example 4

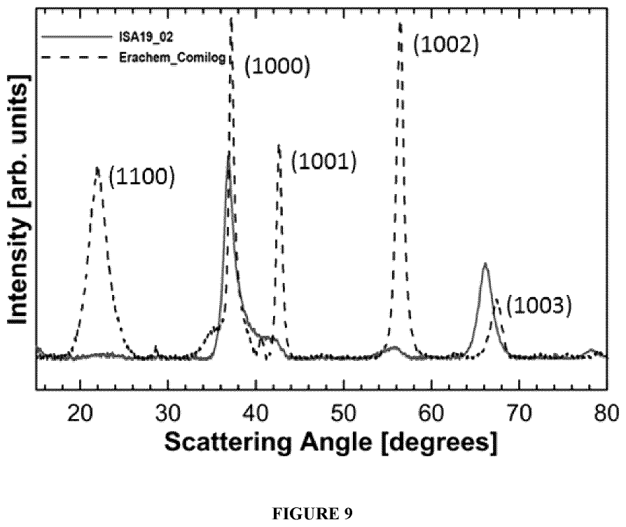

Referring to FIG. 9, a comparison of the XRD diffractograms of an EMD currently commercially available (i.e. Erachem) and of a neutral EMD (i.e. ISA019_02—see Table 1) is provided. Referring to the dotted plot in FIG. 9, there are peaks occurring at about 22° (assignable to ramsdellite), about 37° (assignable to akhtenskite), about 42° (assignable to akhtenskite), about 56° (assignable to akhtenskite), and about 67° (assignable to akhtenskite).

With reference to the peak location 1100 occurring at 22° (ramsdellite), and applying the Scherrer equation thereto, it was determined that the Ramsdellite grain size present in Erachem is approximately 3.2 nm. Through similar application and calculation, it was determined that the ramsdellite grain size present in ISA19_02 is approximately 1 nm. The difference in grain size suggests that at least a portion of the ramsdellite present in ISA19_02 is more disordered than the ramsdellite present in Erachem, and that one or more portions thereof may exhibit amorphicity. A lower intensity of the peak 1100 further suggests that the ramsdellite present in ISA19_02 is less ordered than the ramsdellite present in Erachem.

With reference to the peak location 1003 occurring at 67° (akhtenskite), and applying the Scherrer equation thereto, it was determined that the akhtenskite grain size present in Erachem is approximately 6.3 nm. Through similar application and calculation, it was determined that the akhtenskite grain size present in ISA19_02 is approximately 5.2 nm. The difference in grain size suggests that the akhtenskite present in ISA19_02 is more disordered than the akhtenskite present in Erachem. A lower intensity of the peaks occurring at locations 1000, 1001, and 1002 further suggests that the akhtenskite (and the planes thereof) present in ISA19_02 is less ordered than the akhtenskite present in Erachem.

In addition, the occurrence peaks at locations 1000, 1001, 1002, and 1003 (all corresponding to akhtenskite) are shifted to smaller angles for ISA19_02 when compared to the same peaks for Erachem. Such shifting suggests that the distance between akhtenskite atomic planes is greater in ISA19_02 than in Erachem. Similar observations were made for other neutral EMDs over EMDs that are currently commercially available. The summary of the analysis of various neutral EMDs, as well as EMDs that are commercially available, is provided in Table 5 as follows:

TABLE 5

| Sample | Crystal plane | 2θ (°) | d (Å) |
|---|---|---|---|
| Erachem | 100 | 37.2400 | 2.415 |
| | 101 | 42.6770 | 2.120 |
| | 102 | 56.4641 | 1.630 |
| | 110 | 67.5027 | 1.389 |
| ISA19_02 | 100 | 36.8680 | 2.438 |
| | 101 | 42.0412 | 2.149 |
| | 102 | 55.5911 | 1.653 |
| | 110 | 66.1523 | 1.413 |
| NiZnAc | 100 | 36.9290 | 2.434 |
| | 101 | 42.1279 | 2.145 |
| | 102 | 55.5258 | 1.655 |
| | 110 | 66.0789 | 1.414 |
| ISA019_01 | 100 | 37.0769 | 2.425 |
| | 101 | 42.4400 | 2.130 |
| | 102 | 56.1405 | 1.638 |
| | 110 | 66.7269 | 1.402 |
| ISA019_05 | 100 | 36.9820 | 2.431 |
| | 101 | 42.2470 | 2.139 |
| | 102 | 55.9342 | 1.644 |
| | 110 | 66.4334 | 1.407 |
| FNB088 | 100 | 37.005 | 2.429 |
| | 101 | 42.399 | 2.132 |
| | 102 | 56.0432 | 1.641 |
| | 110 | 66.4734 | 1.406 |
| TOSOH-HH | 100 | 37.3522 | 2.410 |
| | 101 | 42.7717 | 2.116 |
| | 102 | 56.5075 | 1.628 |
| | 110 | 67.5565 | 1.388 |

### General:

It is contemplated that any part of any aspect or embodiment discussed in this specification may be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

Unless defined otherwise, all technical and scientific terms used herein have the same meaning as is commonly understood by one of ordinary skill in the art to which this invention belongs. In addition, any citation of references herein is not to be construed nor considered as an admission that such references are prior art to the present invention.

The scope of the claims should not be limited by the example embodiments set forth herein, but should be given the broadest interpretation consistent with the description as a whole.

1. An electrolytic manganese dioxide composition comprising two manganese dioxide phases, at least one of the two manganese dioxide phases having at least a portion that exhibits amorphicity.

2. The electrolytic manganese dioxide composition of claim 1, wherein the two manganese dioxide phases are akhtenskite and ramsdellite.

3. The electrolytic manganese dioxide composition of claim 1, wherein the ratio of the akhtenskite to the ramsdellite is between 9:1 and 1:3.

4. The electrolytic manganese dioxide composition of claim 3, wherein the ratio of the akhtenskite to the ramsdellite is about 1:3.

5. A battery comprising: (a) a cathode comprising the electrolytic manganese dioxide composition of claim 1; (b) an anode; (c) a separator disposed between the cathode and the anode; (d) an electrolytic solution; the electrolytic solution in contact with the cathode, the anode, and the separator.

6. The battery of claim 5, wherein the electrolytic solution comprises a zinc salt.

7. The battery of claim 6, wherein the zinc salt is selected from the group consisting of zinc sulfate, zinc chloride, zinc nitrate, zinc triphlate, and any combination thereof.

8. The battery of claim 7, wherein the zinc salt is zinc sulfate and the concentration of the zinc sulfate in the electrolytic solution is between 0.5M and 2.5M.

9. The battery of claim 8, wherein the concentration of the zinc sulfate in the electrolytic solution is 2.0M.

10. The battery of claim 6, wherein the electrolytic solution further comprises a manganese species.

11. The battery of claim 10, wherein the manganese species is manganese sulfate.

12. The battery of claim 11, wherein the zinc salt is zinc sulfate, wherein the concentration of the zinc sulfate in the electrolytic solution is between 0.5M and 2.5M, and wherein the concentration of the manganese sulfate in the electrolytic solution is between 0.1M and 0.2M.

13. The battery of claim 11, wherein the concentration of the manganese sulfate in the electrolytic solution is between 0.1M and 0.2M.

14. The battery of claim 6, the electrolytic solution having a pH of between 3 and 7.

15. The battery of claim 14, wherein the pH is between 3.5 and 4.5.

16. (canceled)

17. The battery of claim 6, the electrolytic solution further comprising a pH buffer system.

18. The battery of claim 17, the electrolytic solution having a pH of between 4.5 and 5.5.

19. A method of manufacturing the electrolytic manganese dioxide composition of claim 1, the method comprising:
(a) providing an electrochemical cell comprising a cathode, an anode, a separator in between the cathode and the anode, wherein: (i) the cathode, the anode, and the separator are in fluid contact with an electrolytic solution; and (ii) the electrolytic solution comprises a species comprising manganese;
(b) applying a potential of between about 1.8 V_{cell} n and about 2.5 V_{cell} n between the cathode and the anode over a pre-determined period of time;
(c) forming the electrolytic manganese dioxide composition and depositing the electrolytic manganese dioxide composition onto the anode; and
(d) maintaining the pH of the electrolytic solution between 3 and 7.

20. The method of claim 19, further comprising applying a pressure between 10 PSI and 170 PSI during deposition of the electrolytic manganese dioxide composition onto the anode.

21. (canceled)

22. A method of manufacturing the electrolytic manganese dioxide composition of claim 1, the method comprising:
(a) providing a cell comprising a cathode, an anode, a separator in between the cathode and the anode, wherein: (i) the cathode, the anode, and the separator are in fluid contact with an electrolytic solution; and (ii) the electrolytic solution comprises a species comprising manganese;
(b) charging and discharging the cell;
(c) holding the cell at a potential for two or more hours prior to discharging the cell;
(d) forming the electrolytic manganese dioxide composition and depositing the electrolytic manganese dioxide composition onto the anode.

23. (canceled)

24. (canceled)

25. (canceled)
